(19) United States
(12) Patent Application Publication
(10) Pub. No.: US 2023/0315103 A1
(43) Pub. Date: Oct. 5, 2023

(54) PERCEPTION AND CONTROL SYSTEM OF AUTONOMOUS SNOWFIELD-ROAMING ROBOT AND OPERATION AND PATH PLANNING METHOD THEREOF

(71) Applicant: Harbin Institute of Technology, Harbin (CN)

(72) Inventors: Gangfeng LIU, Harbin (CN); Yongsheng LUO, Harbin (CN); Lefan GUO, Harbin (CN); Changle LI, Harbin (CN); Xuehe ZHANG, Harbin (CN); Jie ZHAO, Harbin (CN)

(21) Appl. No.: 18/068,311

(22) Filed: Dec. 19, 2022

(30) Foreign Application Priority Data
Mar. 22, 2022 (CN) 202210283496.2

(51) Int. Cl. G05D 1/02

(52) U.S. Cl. CPC G05D 1/0214; G05D 1/0236; G05D 1/0268; G05D 1/0278; G05D 2201/0207

(57) ABSTRACT

A perception and control system of an autonomous snowfield-roaming robot and an operation and path planning method thereof are provided. The perception system is configured to perceive the robot’s own state and an extreme snow environment where the robot is located; the control system is configured to realize an autonomous navigation movement and obstacle avoidance of the robot for stability and reliability of robot roaming, wherein the robot uses energy reasonably based on a wind farm environment so as to achieve navigation with sail assistance finally; the execution mechanism is configured to execute control instructions and an operation task issued by the control system so as to realize snowfield roaming; and the remote monitoring module is configured to monitor state information of the robot, and to issue the operation task and target path to the control system for operation and global path planning.

### CROSS REFERENCE TO RELATED APPLICATION

This patent application claims the benefit and priority of Chinese Patent Application No. 202210283496.2, entitled “Perception and Control System of Autonomous Snowfield-Roaming Robot and Operation and Path Planning Method thereof” filed on Mar. 22, 2022, the disclosure of which is incorporated by reference herein in its entirety as part of the present application.

### TECHNICAL FIELD

The present disclosure relates to a field of a robot, in particular to a perception and control system of an autonomous snowfield-roaming robot and an operation and path planning method thereof.

### BACKGROUND ART

Although autonomous navigation and movements of the mobile robots are no longer difficult as the technology of mobile robots becoming more and more mature, most mobile robots move autonomously in a known indoor environment. For some special outdoor environments, especially a snowfield environment, it is difficult to achieve a large-scale robotic operation due to problems of an extreme climate, uncertain road conditions, unstable communication, energy supply, etc.

For example, for scientific investigation in a polar environment, there are great risks and harm to carry out polar scientific investigation tasks in the polar environment as the polar environment is covered by ice and snow all year round and thus the environment is harsh and the climate is cold. Therefore, realizing robotic scientific investigation is a technical problem urgent to be solved. At the same time, the polar region contains rich wind resources. If the robot can use the resource reasonably, it can achieve long-distance, large-scale, and low energy consumption operations.

### SUMMARY

A perception and control system of an autonomous snowfield-roaming robot and an operation and path planning method thereof provided by the present disclosure can be used to solve a problem of long-distance and large-scale autonomous roaming in a snow environment and possible overturning when moving ahead with a sail assistance navigation.

The present disclosure is implemented through the following technical solutions.

A perception and control system of an autonomous snowfield-roaming robot, includes: a perception system, a control system, an execution mechanism and a remote monitoring module.

The perception system is configured to perceive an extreme snow environment where the robot is located and the robot’s own state.

The control system is configured to realize an autonomous navigation movement and obstacle avoidance of the robot for stability and reliability of robot roaming, and meanwhile the robot uses energy reasonably with an assistance of a wind farm environment so as to achieve navigation with sail assistance finally.

The execution mechanism is configured to execute control instructions and an operation task issued by the control system so as to realize snowfield-roaming.

The remote monitoring module is configured to monitor state information of the robot, and to issue the operation task and a target path to the control system for operation and global path planning.

In an embodiment of the perception and control system of the autonomous snowfield-roaming robot, the perception system transmits a signal to the control system; the control system transmits a signal to the execution mechanism; a two-way signal transmission is conducted between the control system and the remote monitoring module; and the execution mechanism feeds back a perception signal to a robot body perception module of the perception system.

In an embodiment of the perception and control system of the autonomous snowfield-roaming robot, the perception system includes an external environment perception module and a robot body perception module.

The external environment perception module is configured to perceive external environment information.

The robot body perception module is configured to perceive information of the robot’s own state.

In an embodiment of the perception and control system of the autonomous snowfield-roaming robot, the external environment perception module includes a position and attitude perception module, an environment obstacle perception module, and a wind farm environment perception module. Where the position and attitude perception module includes an inertia measurement unit and a global navigation satellite system and real-time kinematic positioning system; the environment obstacle perception module includes a camera and a laser rangefinder; and the wind farm environment perception module includes a wind direction sensor and a wind speed sensor.

The position and attitude perception module is configured to perceive attitude and heading information and position information of the robot; the environment obstacle perception module is configured to perceive an obstacle and a characteristic target in an operating environment of the robot; and the wind farm environment perception module is configured to perceive wind farm information in an environment including apparent wind speed and wind direction.

In an embodiment of the perception and control system of the autonomous snowfield-roaming robot, the robot body perception module includes an energy consumption monitoring device, a robot temperature monitoring device, and a sail attack angle sensor. Where the energy consumption monitoring device is configured to monitor energy consumption of each execution component during an operation of the robot; the robot temperature monitoring device is configured to detect an actual temperature of a robot-carrying device, in combination with a heating device to ensure that the robot-carrying device operates within an allowable operating temperature range, thereby achieving a closed-loop temperature control; and the sail attack angle sensor is configured to measure sail attack angle information.

In an embodiment of the perception and control system of the autonomous snowfield-roaming robot, the control system includes a perception information processing module, an autonomous robot decision-making module, a primary motion control module of the robot, and a secondary motion control module of the robot. Where, the perception information processing module is configured to receive the signal from the perception system, transmit a received real-time position state signal to the remote monitoring module, and transmit the signal to the autonomous robot decision-making module; the autonomous robot decision-making module is configured to receive the target path and operation task instructions from the remote monitoring module, and transmit a signal to the primary motion control module of the robot; and a two-way signal transmission is conducted between the primary motion control module of the robot and the secondary motion control module of the robot.

In an embodiment of the perception and control system of the autonomous snowfield-roaming robot, the execution mechanism includes but is not limited to a temperature control module, a sail mechanism control module, a main power control module of the robot, a steering mechanism control module of the robot, and an anti-overturning control module of the robot. A driving mechanism of the robot, a steering mechanism of the robot, and a temperature control module of the robot feed back acquired state signals to the robot body perception module respectively.

In an embodiment, an operation and path planning method for the perception and control system of the autonomous snowfield-roaming robot, includes:
Step 1: controlling a sail angle adjustment mechanism according to whether the robot has a risk of heeling;
Step 2: controlling, according to an expected path, a driving direction and a driving speed of the robot to achieve trajectory tracking; and
Step 3: controlling actions of corresponding operation mechanisms according to requirements of the operation task.

In an embodiment of the operation and path planning method, controlling the sail angle adjustment mechanism in Step 1 includes:
Step 1.1: acquiring robot attitude information via a position and attitude perception module;
Step 1.2: determining whether the robot has a risk of heeling based on the robot attitude information, wherein when the risk of heeling exists, go to step 1.3 and when the risk of heeling does not exist, go to step 1.4;
Step 1.3: controlling the sail angle adjustment mechanism to adjust a sail attack angle to be 0; and
Step 1.4: controlling the sail angle adjustment mechanism to keep a sail attack angle under a greatest navigation assistance of a current wind direction.

The beneficial effects of the present disclosure are as follows:

The present disclosure can realize a remote task deployment and state monitoring for human and the robot in the extreme snow environment.

The robot of the present disclosure is suitable not only for a common snow environment, but also for an extreme environment containing a large amount of wind energy resources, such as the polar region.

According to the present disclosure, the wind energy is used, and snowfield roaming becomes more energy-saving, more efficient, and green, and the present disclosure has higher engineering application value.

The present disclosure enables the robot to more intelligently, more reliably and more energy-efficiently achieve long-distance and large-scale autonomous roaming in the snow environment.

### BRIEF DESCRIPTION OF THE DRAWINGS

FIG. 1 is a block diagram of a robot system according to the present disclosure;

FIG. 2 is a diagram of a perception system according to the present disclosure;

FIG. 3 is a diagram of a control system according to the present disclosure;

FIG. 4 is a diagram showing a secondary motion control mode according to the present disclosure;

FIG. 5 is a diagram of a composite power walking mode according to the present disclosure; and

FIG. 6 is a structural diagram in one embodiment according to the present disclosure.

### DETAILED DESCRIPTION OF THE EMBODIMENTS

In the following, the technical solutions in the embodiments of the present disclosure will be clearly and completely described in combination with the drawings in the embodiments of the present disclosure. Obviously, the described embodiments are only a part of the embodiments of the present disclosure, rather than all the embodiments. Based on the embodiments of the present disclosure, all other embodiments obtained by a person of ordinary skill in the art without any creative effort fall into the scope of the present disclosure.

A perception and control system of an autonomous snowfield-roaming robot includes: a perception system, a control system, an execution mechanism and a remote monitoring module.

The perception system is configured to perceive an extreme snowfield environment where the robot is located and the robot’s own state.

The control system is configured to realize an autonomous navigation movement and obstacle avoidance of the robot for stability and reliability of roaming of the robot. Meanwhile, the robot uses energy reasonably with the help of a wind farm environment so as to achieve navigation with sail assistance finally.

The execution mechanism is configured to execute control instructions and an operation task issued by the control system so as to realize snowfield roaming.

The remote monitoring module is configured to monitor state information of the robot, and to issue the operation task and a target path to the control system for operation and global path planning.

In the perception and control system of the autonomous snowfield-roaming robot, the perception system transmits a signal to the control system, the control system transmits a signal to the execution mechanism, the control system and the remote monitoring module transmit a signal to each other, and the execution mechanism feeds back a perception signal to a robot body perception module of the perception system.

In the perception and control system of the autonomous snowfield-roaming robot, the perception system includes an external environment perception module and a robot body perception module.

The external environment perception module is configured to perceive external environment information. The external environment information includes robot position information, robot speed information, robot acceleration information, robot heading, robot attitude information, camera image and depth information, distance measured through a laser rangefinder, apparent wind speed of the robot, and wind direction information.

The robot body perception module is configured to perceive the state information of the robot itself, where the state information of the robot itself includes robot energy consumption power information, robot temperature information, and robot sail rotation angle information.

In the perception and control system of the autonomous snowfield-roaming robot, the external environment perception module includes a position and attitude perception module, an environment obstacle perception module and a wind farm environment perception module. The position and attitude perception module includes an inertial measurement unit and a global navigation satellite system (GNSS) and real-time kinematic (RTK) positioning system; the environment obstacle perception module includes a camera and a laser rangefinder; and the wind farm environment perception module includes a wind direction sensor and a wind speed sensor.

The position and attitude perception module is configured to perceive attitude and heading information and position information of the robot; the environment obstacle perception module is configured to perceive an obstacle and a characteristic target in an operating environment of the robot; and the wind farm environment perception module is configured to perceive wind farm information in an environment including apparent wind speed and wind direction.

The position and attitude perception device includes, but is not limited to, an inertial measurement unit (IMU) and a global navigation satellite system and real-time kinematic (GNSS+RTK) positioning system, which is configured to perceive attitude and heading information and position information of the robot. The environment obstacle perception device includes, but is not limited to, a camera and a laser rangefinder, which is configured to perceive an obstacle and a characteristic target of an operating environment of the robot. The wind farm environment perception device includes, but is not limited to, a wind direction sensor and a wind speed sensor, which is configured to perceive wind farm information in the environment including apparent wind speed and wind direction.

In the perception and control system of the autonomous snowfield-roaming robot, the robot body perception module includes an energy consumption monitoring device, a robot temperature monitoring device and a sail attack angle sensor. Where the energy consumption monitoring device is configured to monitor energy consumption of each execution component during operation of the robot; the robot temperature monitoring device is configured to detect an actual temperature of a robot-carrying device, in combination with a heating device to ensure that the robot-carrying device operates within an allowable operating temperature range, thereby achieving a closed-loop temperature control; and the sail attack angle sensor is configured to measure sail attack angle information.

The robot body state perception system device includes, but is not limited to, an energy consumption monitoring device which is configured to monitor information such as energy consumption of each execution component and battery remaining power during operation of the robot; a robot temperature monitoring device which is configured to detect an actual temperature of a robot-carrying device, in combination with a heating device to ensure that the robot-carrying device operates within an allowable operating temperature range, thereby achieving a closed-loop temperature control; and a sail attack angle sensor which is configured to measure sail attack angle information.

In the perception and control system of the autonomous snowfield-roaming robot, the control system includes a perception information processing module, an autonomous robot decision-making module, a primary motion control module of the robot, and a secondary motion control module of the robot. The perception information processing module is configured to receive the signal from the perception system, transmit a received real-time position state signal to the remote monitoring module, and transmit the signal to the autonomous robot decision-making module; the autonomous robot decision-making module is configured to receive a target path and operation task instructions from the remote monitoring module, and the autonomous robot decision-making module is further configured to transmit the signal to the primary motion control module of the robot; and a two-way signal transmission is conducted between the main motion control module for the robot and the secondary motion control module for a robot.

The primary motion control module of the robot adopts an artificial intelligence (AI) computer, and the secondary motion control module of the robot adopts a single-chip microcomputer.

The control system acquires the environment where the robot is located and its own state based on the robot perception system, and transmits the perception information into a main control unit of the control system of the robot for perception information processing. The processed data is transmitted to the remote monitoring unit and the autonomous robot decision-making module, the autonomous decision-making module conducts operation and an overall path planning in combination with the operation task and target path issued by the remote control unit. At the same time, the autonomous decision-making module plans a local obstacle avoidance path according to the processed environment obstacle information, and determines whether the robot has a risk of heeling based on the robot attitude information. The primary motion control module of the robot acquires decision-making information for operation and path planning and resolving, sends action instructions to the secondary motion control module, and the secondary motion control module controls actions of the execution mechanism to achieve snowfield roaming.

In the perception and control system of the autonomous snowfield-roaming robot, the execution mechanism includes, but is not limited to, a temperature control module, a sail mechanism control module, a main power control module of the robot, a steering mechanism control module of the robot, and an anti-overturning control module of the robot. The driving mechanism of the robot, the steering mechanism of the robot and the temperature control module of the robot acquire state signals and feed back the acquired state signals to the robot body perception module respectively.

The sail mechanism control module and the main power control module of the robot are power control parts of walking of the robot. The robot can perform composite power walking including but not limited to a main power walking mode, a wind power walking mode, and a walking mode combining the main power walking mode and the wind power walking mode.

An operation and path planning method for the perception and control system of the autonomous snowfield-roaming robot, includes:
Step 1: controlling a sail angle adjustment mechanism according to whether the robot has a risk of heeling;
Step 2: controlling, according to an expected path, a driving direction and a driving speed of the robot to achieve trajectory tracking; and
Step 3: controlling actions of corresponding operation mechanisms according to requirements of the operation task.

In the operation and path planning method, controlling the sail angle adjustment mechanism in step 1 includes:
Step 1.1: acquiring robot attitude information via a position and attitude perception module;
Step 1.2: determining whether the robot has a risk of heeling based on the robot attitude information of Step 1.1, that is, determining whether a heeling angle of the robot reaches a set threshold, where if the threshold is exceeded, there is the risk of heeling and Step 1.3 is performed, and otherwise the risk of heeling does not exist and Step 1.4 is performed;
Step 1.3: controlling the sail angle adjustment mechanism to adjust a sail attack angle to be 0; and
Step 1.4: controlling the sail angle adjustment mechanism to keep a sail attack angle under a greatest navigation assistance of a current wind direction.

The sail attack angle under the greatest navigation assistance refers to a sail attack angle, obtained by the simulation software, that provides the maximum forward lift in the corresponding wind speed and wind direction environment.

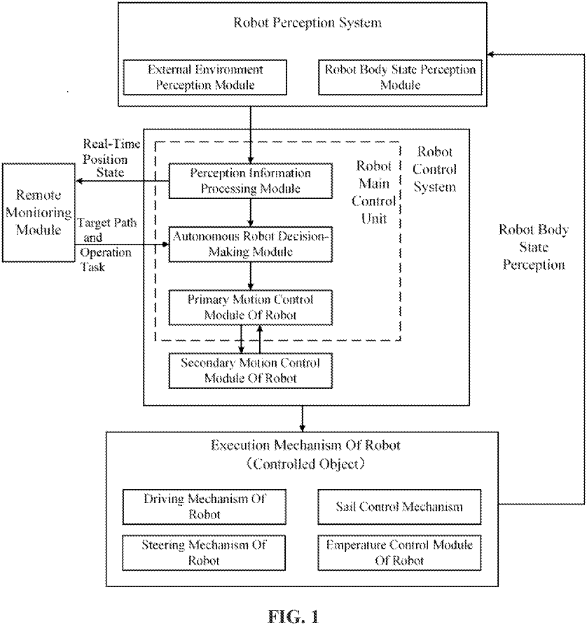

FIG. 1 shows a block diagram of an overall system of the autonomous snowfield-roaming robot, which includes a robot perception system, a robot control system, a remote monitoring module, and a robot execution mechanism. The robot perception system includes, but is not limited to, an external environment perception module and a robot body state perception module. The robot control system includes, but is not limited to, a perception information processing module, an autonomous robot decision-making module, a primary motion control module of the robot, and a secondary motion control module of the robot.

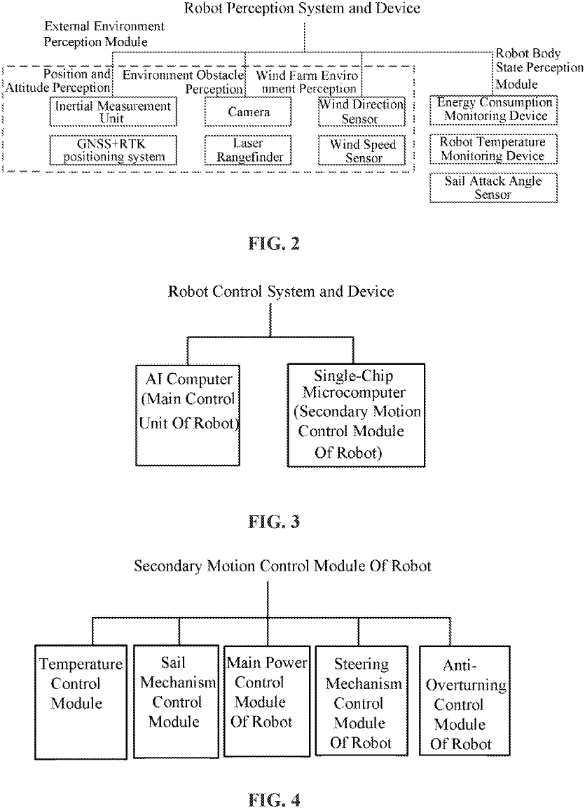

Referring to FIG. 2, a robot perception device includes a position and attitude perception device, an environment obstacle perception device, a wind farm environment perception device, and an energy consumption monitoring device, a robot temperature monitoring device, and a sail attack angle sensor.

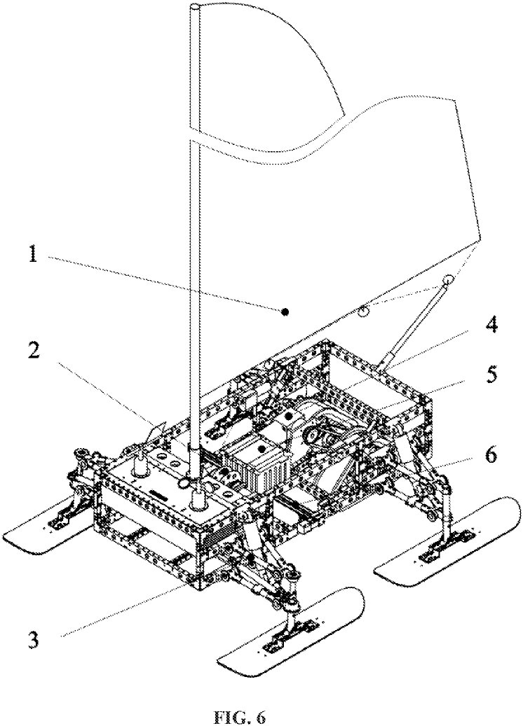

Specifically, a sail sled robot structure is shown in FIG. 6, including a navigation assistance sail, a sail control mechanism, a steering mechanism of a robot, a main power driving mechanism of the robot, a battery, and an anti-overturn mechanism of the robot. Among them, perception devices of the robot are installed as follows: the position and attitude perception device is installed at a front end of the robot; the environment obstacle perception device is installed on a chassis and a head of the robot; the wind farm environment perception device is installed on a surface of the front end of the robot; the energy consumption monitoring device is connected to the battery and a circuit of each driving hardware; the robot temperature monitoring device is installed on surfaces of each driving hardware; and the sail attack angle sensor is installed on the sail control mechanism.

Specifically, referring to FIG. 2, the position and attitude perception device of this embodiment is selected as the YIN660 series of Wuhan Yesense Technologies Co., Ltd. The device is small in size and with low power consumption, and can achieve centimeter-level high-precision positioning and 0.1-degree attitude measurement. The environment obstacle perception device is selected as the camera and the laser rangefinder. The wind farm environment perception device is implemented as a three-cup wind direction sensor and a three-cup wind speed sensor of Shenzhen Huanxinyun Technology Co., Ltd.

The control system of the robot shown in FIG. 3 includes an AI computer (main control unit of the robot), a single-chip microcomputer and a servo driver (secondary motion control module of the robot). Specifically, the AI computer of this embodiment is selected as Raspberry Pi 4b, and the single-chip microcomputer is implemented as STM32F103ZET6; the servo driver is selected as a driver matching with a main power servo motor.

The main control unit of the control system of the robot is connected with each device of the perception system via a wired connection. Since the main control unit Raspberry Pi 4b has multiple serial communication ports and interfaces converting USB to serial port, and thus the devices of the perception system are connected to the Raspberry Pi 4b (main control unit) via the serial ports. Considering that the number of serial ports of Raspberry Pi is smaller than the number of perception devices, in this embodiment, the wind farm environment perception device and robot body state perception module are connected to the Raspberry Pi 4b through the RS485 bus for data transmission.

The perceived information processing module of the main control unit (Raspberry Pi 4b) of the control system for the robot obtains the data, and then performs processing, such as sampling, A/D conversion, decoding, coordinate transformation, and filtering, on the data. The processed information is transferred to the remote monitoring module through the wireless local area network. The remote monitoring module in this embodiment is selected as a personal computer (PC), where the interactive interface with the robot is programmed using QT. Remote monitoring PC can acquire the real-time state and position of the robot, and can transmit the target path and operation task through the local area network. The entire set of wireless data transmission hardware is built by an antenna carried by the robot and an antenna connected to the remote PC.

The autonomous decision-making module of the main control unit (Raspberry Pi 4b) of the control system of the robot performs, in combination with the operation task and target path sent by the remote monitoring PC, operation and global path planning. At the same time, the autonomous decision-making module performs a local obstacle avoidance path planning based on the processed environment obstacle information, and determines whether the robot has a risk of heeling according to the robot attitude information.

The primary motion control module of the robot acquires decision-making information for operation and path planning and resolving. Taking the path planning and resolving as an example, in this embodiment, the autonomous decision-making expected path is split into multiple sub-paths. In each sub-path, the required information including driving speed and steering angle of the robot are calculated based on current positioning attitude information. This type of action instructions related to actions of the robot execution mechanism will be sent to the secondary motion control module.

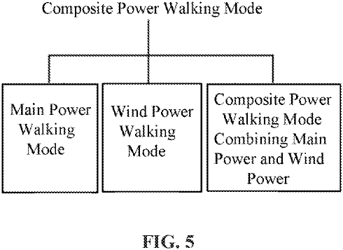

The secondary motion control module shown in FIG. 4 includes the temperature control module, the sail mechanism control module, the main power control module of the robot, the steering mechanism control module of the robot, and the anti-overturning control module of the robot.

Specifically, the secondary motion control module of the robot (single-chip microcomputer, servo drive) is connected to the main control unit for data transmission through the serial port. Where, after the single-chip microcomputer obtains the steering angle information of the robot, the single-chip microcomputer will provide a high level pulse width signal of 3.3 V-5 V to drive the steering engine so as to realize pulse width modulation (PWM) waveform control. When the single-chip microcomputer obtains action instructions from the anti-overturn mechanism of the robot, it drives a stepping motor to prevent the robot from being overturned by wind. The information such as the driving speed of the robot and a motor speed of the sail mechanism is sent to the single-chip microcomputer firstly, the single-chip microcomputer sends the motor speed information to the servo driver using the MODBUS communication protocol, and then the servo driver drives a direct current (DC) servo motor.

Specifically, referring to FIG. 5, the robot can achieve composite power walking according to the perceived information, including the main power walking mode, the wind power walking mode, and the walking mode combining the main power walking mode and the wind power walking mode. In this embodiment, the robot will keep a sail attack angle equal to a sail attack angle under the greatest navigation assistance according to the current wind speed and wind direction in the wind farm. The sail attack angle under the greatest navigation assistance refers to a sail attack angle, obtained by ANSYS, that provides a maximum forward lift coefficient in the corresponding wind speed and wind direction environment.

FIG. 6 shows the Navigation assistance sail 1, the sail control mechanism 2, the steering mechanism of the robot 3, the main power driving mechanism of the robot 4, the battery 5, and the anti-overturn mechanism of the robot 6.

If the driving speed of the robot exceeds a pre-set threshold and there is no risk of overturning, the robot will adopt the wind power driving mode and raise the main power mechanism (a crawler mechanism) of the robot in this embodiment.

If the driving speed of the robot does not exceed the pre-set threshold, and there is no risk of overturning, the robot will adopt the walking mode combining the main power walking mode and the wind power walking mode, which ensures that the robot has the source of main power, and the sail attack angle is equal to a sail attack angle under the greatest navigation assistance.

If the robot has a risk of overturning, the robot will quickly control the sail angle adjustment mechanism to adjust the sail attack angle to be 0 degree, so as to ensure that the force applied to the sail is minimum and the risk of overturning of the robot can be avoided.

Specifically, the robot perception system and device, and the robot control system and device are powered by a battery of 48 V and 20 AH, where different step-down modules, including a conversion module of 48 V to 24 V, a conversion module of 48 V to 12 V, a conversion module of 12 V to 5 V and a conversion module of 12 V to 3.3 V, are provided for different devices.

What is claimed is:

1. A perception and control system of an autonomous snowfield-roaming robot, comprising: a perception system, a control system, an execution mechanism and a remote monitoring module, wherein
the perception system is configured to perceive an extreme snow environment where the robot is located and the robot’s own state;
the control system is configured to realize an autonomous navigation movement and obstacle avoidance of the robot for stability and reliability of robot roaming, and the robot uses energy reasonably with an assistance of a wind farm environment so as to achieve navigation with sail assistance finally;
the execution mechanism is configured to execute control instructions and an operation task issued by the control system so as to realize snowfield roaming; and
the remote monitoring module is configured to monitor state information of the robot, and to issue the operation task and a target path to the control system for operation and global path planning.

2. The perception and control system of the autonomous snowfield-roaming robot according to claim 1, wherein the perception system transmits a signal to the control system; the control system transmits a signal to the execution mechanism; a two-way signal transmission is conducted between the control system and the remote monitoring module; and the execution mechanism feeds back a perception signal to a robot body perception module of the perception system.

3. The perception and control system of the autonomous snowfield-roaming robot according to claim 1, wherein the perception system comprises an external environment perception module and a robot body perception module, wherein
the external environment perception module is configured to perceive external environment information; and
the robot body perception module is configured to perceive information of the robot’s own state.

4. The perception and control system of the autonomous snowfield-roaming robot according to claim 3, wherein the external environment perception module comprises a position and attitude perception module, an environment obstacle perception module, and a wind farm environment perception module, wherein
the position and attitude perception module includes an inertial measurement unit and a global navigation satellite system and real-time kinematic positioning system; the environment obstacle perception module includes a camera and a laser rangefinder; and the wind farm environment perception module includes a wind direction sensor and a wind speed sensor; and wherein
the position and attitude perception module is configured to perceive attitude and heading information and position information of the robot; the environment obstacle perception module is configured to perceive an obstacle and a characteristic target in an operating environment of the robot; and the wind farm environment perception module is configured to perceive wind farm information in an environment including apparent wind speed and wind direction.

5. The perception and control system of the autonomous snowfield-roaming robot according to claim 3, wherein the robot body perception module comprises an energy consumption monitoring device, a robot temperature monitoring device, and a sail attack angle sensor, wherein
the energy consumption monitoring device is configured to monitor energy consumption of each execution component during an operation of the robot; the robot temperature monitoring device is configured to detect an actual temperature of a robot-carrying device, in combination with a heating device to ensure that the robot-carrying device operates within an allowable operating temperature range, thereby achieving a closed-loop temperature control; and the sail attack angle sensor is configured to measure sail attack angle information.

6. The perception and control system of the autonomous snowfield-roaming robot according to claim 2, wherein the control system comprises a perception information processing module, an autonomous robot decision-making module, a primary motion control module of the robot, and a secondary motion control module of the robot, wherein
the perception information processing module is configured to receive the signal from the perception system, transmit a received real-time position state signal to the remote monitoring module, and transmit the signal to the autonomous robot decision-making module; the autonomous robot decision-making module is configured to receive the target path and operation task instructions from the remote monitoring module, and transmit a signal to the primary motion control module of the robot; and a two-way signal transmission is conducted between the primary motion control module of the robot and the secondary motion control module of the robot.

7. The perception and control system of the autonomous snowfield-roaming robot according to claim 5, wherein the execution mechanism comprises a temperature control module, a sail mechanism control module, a main power control module of the robot, a steering mechanism control module of the robot, and an anti-overturning control module of the robot, wherein
a driving mechanism of the robot, a steering mechanism of the robot and a temperature control module of the robot feed back acquired state signals to the robot body perception module respectively.

8. An operation and path planning method for the perception and control system of the autonomous snowfield-roaming robot, wherein
the perception and control system of the autonomous snowfield-roaming robot comprises: a perception system, a control system, an execution mechanism and a remote monitoring module, wherein
the perception system is configured to perceive an extreme snow environment where the robot is located and the robot’s own state;
the control system is configured to realize an autonomous navigation movement and obstacle avoidance of the robot for stability and reliability of robot roaming, and the robot uses energy reasonably with an assistance of a wind farm environment so as to achieve navigation with sail assistance finally;
the execution mechanism is configured to execute control instructions and an operation task issued by the control system so as to realize snowfield roaming; and
the remote monitoring module is configured to monitor state information of the robot, and to issue the operation task and a target path to the control system for operation and global path planning; and
the method comprising:
step 1: controlling a sail angle adjustment mechanism according to whether the robot has a risk of heeling;
step 2: controlling, according to an expected path, a driving direction and a driving speed of the robot to achieve trajectory tracking; and
step 3: controlling actions of corresponding operation mechanisms according to requirements of the operation task.

9. The operation and path planning method for the perception and control system of the autonomous snowfield-roaming robot according to claim 8, wherein controlling the sail angle adjustment mechanism in step 1 comprises:
step 1.1: acquiring robot attitude information via a position and attitude perception module;
step 1.2: determining whether the robot has a risk of heeling based on the robot attitude information, wherein when the risk of heeling exists, go to step 1.3 and when the risk of heeling does not exist, go to step 1.4;
step 1.3: controlling the sail angle adjustment mechanism to adjust a sail attack angle to be 0; and
step 1.4: controlling the sail angle adjustment mechanism to keep a sail attack angle under a greatest navigation assistance of a current wind direction.

10. The operation and path planning method for the perception and control system of the autonomous snowfield-roaming robot according to claim 8, wherein the perception system transmits a signal to the control system; the control system transmits a signal to the execution mechanism; a two-way signal transmission is conducted between the control system and the remote monitoring module; and the execution mechanism feeds back a perception signal to a robot body perception module of the perception system.

11. The operation and path planning method for the perception and control system of the autonomous snowfield-roaming robot according to claim 10, wherein controlling the sail angle adjustment mechanism in step 1 comprises:
step 1.1: acquiring robot attitude information via a position and attitude perception module;
step 1.2: determining whether the robot has a risk of heeling based on the robot attitude information, wherein when the risk of heeling exists, go to step 1.3 and when the risk of heeling does not exist, go to step 1.4;
step 1.3: controlling the sail angle adjustment mechanism to adjust a sail attack angle to be 0 ; and
step 1.4: controlling the sail angle adjustment mechanism to keep a sail attack angle under a greatest navigation assistance of a current wind direction.

12. The operation and path planning method for the perception and control system of the autonomous snowfield-roaming robot according to claim 8, wherein the perception system comprises an external environment perception module and a robot body perception module, wherein
the external environment perception module is configured to perceive external environment information; and
the robot body perception module is configured to perceive information of the robot’s own state.

13. The operation and path planning method for the perception and control system of the autonomous snowfield-roaming robot according to claim 12, wherein controlling the sail angle adjustment mechanism in step 1 comprises:
step 1.1: acquiring robot attitude information via a position and attitude perception module;
step 1.2: determining whether the robot has a risk of heeling based on the robot attitude information, wherein when the risk of heeling exists, go to step 1.3 and when the risk of heeling does not exist, go to step 1.4;
step 1.3: controlling the sail angle adjustment mechanism to adjust a sail attack angle to be 0 ; and
step 1.4: controlling the sail angle adjustment mechanism to keep a sail attack angle under a greatest navigation assistance of a current wind direction.

14. The operation and path planning method for the perception and control system of the autonomous snowfield-roaming robot according to claim 12, wherein the external environment perception module comprises a position and attitude perception module, an environment obstacle perception module, and a wind farm environment perception module, wherein
the position and attitude perception module includes an inertial measurement unit and a global navigation satellite system and real-time kinematic positioning system; the environment obstacle perception module includes a camera and a laser rangefinder; and the wind farm environment perception module includes a wind direction sensor and a wind speed sensor; and wherein
the position and attitude perception module is configured to perceive attitude and heading information and position information of the robot; the environment obstacle perception module is configured to perceive an obstacle and a characteristic target in an operating environment of the robot; and the wind farm environment perception module is configured to perceive wind farm information in an environment including apparent wind speed and wind direction.

15. The operation and path planning method for the perception and control system of the autonomous snowfield-roaming robot according to claim 14, wherein controlling the sail angle adjustment mechanism in step 1 comprises:
step 1.1: acquiring robot attitude information via a position and attitude perception module;
step 1.2: determining whether the robot has a risk of heeling based on the robot attitude information, wherein when the risk of heeling exists, go to step 1.3 and when the risk of heeling does not exist, go to step 1.4;
step 1.3: controlling the sail angle adjustment mechanism to adjust a sail attack angle to be 0 ; and
step 1.4: controlling the sail angle adjustment mechanism to keep a sail attack angle under a greatest navigation assistance of a current wind direction.

16. The operation and path planning method for the perception and control system of the autonomous snowfield-roaming robot according to claim 12, wherein the robot body perception module comprises an energy consumption monitoring device, a robot temperature monitoring device, and a sail attack angle sensor, wherein
the energy consumption monitoring device is configured to monitor energy consumption of each execution component during an operation of the robot; the robot temperature monitoring device is configured to detect an actual temperature of a robot-carrying device, in combination with a heating device to ensure that the robot-carrying device operates within an allowable operating temperature range, thereby achieving a closed-loop temperature control; and the sail attack angle sensor is configured to measure sail attack angle information.

17. The operation and path planning method for the perception and control system of the autonomous snowfield-roaming robot according to claim 16, wherein controlling the sail angle adjustment mechanism in step 1 comprises:
step 1.1: acquiring robot attitude information via a position and attitude perception module;
step 1.2: determining whether the robot has a risk of heeling based on the robot attitude information, wherein when the risk of heeling exists, go to step 1.3 and when the risk of heeling does not exist, go to step 1.4;
step 1.3: controlling the sail angle adjustment mechanism to adjust a sail attack angle to be 0 ; and
step 1.4: controlling the sail angle adjustment mechanism to keep a sail attack angle under a greatest navigation assistance of a current wind direction.

18. The operation and path planning method for the perception and control system of the autonomous snowfield-roaming robot according to claim 10, wherein the control system comprises a perception information processing module, an autonomous robot decision-making module, a primary motion control module of the robot, and a secondary motion control module of the robot, wherein
the perception information processing module is configured to receive the signal from the perception system, transmit a received real-time position state signal to the remote monitoring module, and transmit the signal to the autonomous robot decision-making module; the autonomous robot decision-making module is configured to receive the target path and operation task instructions from the remote monitoring module, and transmit a signal to the primary motion control module of the robot; and a two-way signal transmission is conducted between the primary motion control module of the robot and the secondary motion control module of the robot.

19. The operation and path planning method for the perception and control system of the autonomous snowfield-roaming robot according to claim 18, wherein controlling the sail angle adjustment mechanism in step 1 comprises:
step 1.1: acquiring robot attitude information via a position and attitude perception module;
step 1.2: determining whether the robot has a risk of heeling based on the robot attitude information, wherein when the risk of heeling exists, go to step 1.3 and when the risk of heeling does not exist, go to step 1.4;
step 1.3: controlling the sail angle adjustment mechanism to adjust a sail attack angle to be 0 ; and
step 1.4: controlling the sail angle adjustment mechanism to keep a sail attack angle under a greatest navigation assistance of a current wind direction.

20. The operation and path planning method for the perception and control system of the autonomous snowfield-roaming robot according to claim 16, wherein the execution mechanism comprises a temperature control module, a sail mechanism control module, a main power control module of the robot, a steering mechanism control module of the robot, and an anti-overtuming control module of the robot, wherein
a driving mechanism of the robot, a steering mechanism of the robot and a temperature control module of the robot feed back acquired state signals to the robot body perception module respectively.
